(19) United States
(12) Patent Application Publication
(10) Pub. No.: US 2013/0205958 A1
(43) Pub. Date: Aug. 15, 2013

(54) CUTTING DEVICE AND METHOD OF CUTTING USING THE DEVICE FOR CUTTING STRIPS FROM A BAND OF CORD-REINFORCED UNVULCANIZED RUBBER

(71) Applicants: Cornelis Wouteres Janszen, Harderwijk (NL); Wiebe Herman Ten Wolde, AH Enschede (NL); Gerrit Willem Remmers, Wapenveld (NL)

(72) Inventors: Cornelis Wouteres Janszen, Harderwijk (NL); Wiebe Herman Ten Wolde, AH Enschede (NL); Gerrit Willem Remmers, Wapenveld (NL)

(73) Assignee: VMI HOLLAND B .V., RK Epe (NL)

(21) Appl. No.: 13/806,143

(22) PCT Filed: Jun. 17, 2011
(86) PCT No.: PCT/NL2011/050439

§ 371 Date: Mar. 7, 2013

(30) Foreign Application Priority Data
Jun. 24, 2010 (NL) 2004966

(51) Int. Cl. B26D 3/00; B26D 1/08; B26D 7/26

(52) U.S. Cl. CPC B26D 3/003; B26D 7/26; B26D 1/085
USPC 83/13; 83/581.1

(57) ABSTRACT

The invention relates to a cutting device for cutting strips from a band of cord-reinforced unvulcanized rubber. The device comprises a frame, a first and a second cutting member having a substantially straight first and second cutting edge, respectively, of a hard metal, wherein the first cutting member is fixedly attached to the frame, and the second cutting member is substantially rectilinearly movable by means of a guide rail that is attached to the frame. The second cutting edge is movable along the first cutting edge for cutting the strips. The guide rail on the one hand is hinged to the frame parallel to the first cutting edge, and on the other hand is attached to the frame by means of a tensioning member. The tensioning member is adapted for providing a constant transverse force with which the guide rail is pushed to the first cutting edge. The frame further comprises a stop member for bounding the movement of the guide rail to the first cutting edge.

### BACKGROUND OF THE INVENTION

The invention relates to a cutting device, particularly a cutting device for cutting bands of unvulcanized rubber provided with reinforcement cords.

Such cutting devices are known. For instance Dutch patent 1027733 describes a cutting device for cutting strips from a band of material, particularly a band of unvulcanized rubber, more particularly cord-reinforced unvulcanized rubber, comprising a frame, a first cutting member having a substantially straight first cutting edge, wherein the first cutting member, in this case a lower blade, is fixedly attached to the frame, a second cutting member having a substantially straight second cutting edge, wherein the second cutting member, in this case an upper blade, is substantially rectilinearly movable along a guide block that is attached to the frame, wherein the second cutting edge is movable along the first cutting edge for in cooperation cutting the strips, and a drive for driving the substantially rectilinear movement of the second cutting member, and for carrying the second cutting member.

Particularly when cutting rubber material the mutual distance of the blades, that means the cutting slit, is of importance. As described in the above-mentioned Dutch patent 1027733, it is namely preferable in the actual cutting of rubber material, to use a negative cutting slit. That means that considered from above the upper blade and the lower blade, at least prior to cutting, overlap each other. The expert will recognize that a small overlap of the blades is required in order to prevent mis-cuts. As in that case at least one of the blades is usually curved, that means convex with respect to the other blade or beam, the cutting edges are thus urged against each other during cutting, as a result of which a proper cut is achieved.

A drawback of these known devices is that wear is very high, and the entire device is subjected to large forces during cutting.

In addition cutting composite material, such as cord-reinforced, unvulcanized rubber material has its own specific problems. The unvulcanized rubber material is relatively soft and the cord-reinforcement, which usually comprises a large quantity of steel cables, is hard.

It is among others an object of the invention to improve on this.

### SUMMARY OF THE INVENTION

According to a first aspect the invention provides a cutting device for cutting strips from a band of cord-reinforced unvulcanized rubber, comprising a frame, a first cutting member having a substantially straight first cutting edge, wherein the first cutting member is fixedly attached to the frame, a second cutting member having a substantially straight second cutting edge, wherein the second cutting member is substantially rectilinearly movable by means of a guide rail that is attached to the frame, wherein the second cutting edge is movable along the first cutting edge for in cooperation with the first cutting edge cutting the strips, and a drive for driving the substantially rectilinear movement of the second cutting member, and for carrying the second cutting member, wherein the guide rail on the one hand is hinged to the frame, with a hinge axis that is substantially parallel to the first cutting edge, and that the guide rail on the other hand is attached to the frame by means of a tensioning member, wherein the tensioning member is adapted for, when operational, providing a substantially constant transverse force with which the guide rail is pushed to the first cutting edge, wherein the first and/or second cutting edge is made of a hard metal, and wherein the frame comprises a stop member for bounding the movement of the guide rail in the direction of the first cutting edge.

The invention springs from the inventor's awareness that the cutting force required for cutting composite material, such as cord-reinforced, unvulcanized rubber material, can be relatively low if a sharp blade is used for cutting. The steel cords in rubber tyres are usually built up from filaments having a diameter of approximately 0.1 to 0.3 mm. Good cutting results are achieved when the maximum allowable cutting slit is not larger than approximately ⅓ of the diameter of the smallest filament present. Larger blade slits may lead to an unacceptably rough cutting result or even to mis-cuts.

Particularly in case of long cutting members, the cutting member may bend out in the centre, which may lead to the cutting slit becoming larger than the diameter of the filaments, as a result of which mis-cuts may arise. For that reason the blade holders in the known devices are designed very rigid. Moreover the cutting members are set at an overlap of approximately 0.1 to 0.2 mm (the negative cutting slit mentioned above). The closing force required in these known devices, is a result of the degree of overlap and the rigidity of the blade holders. Indeed with the known devices, which show a high degree of wear and the blades of which become blunt very fast, very large closing forces are required, but also very large transverse forces in order to keep the blades closed or in overlap are required.

Due to the use of hard metal cutting edges the cutting edges remain sharp much longer, and the composite material can be cut with relatively low cutting force. However, the closing forces in the known cutting devices, as described in Dutch patent 1027733, are too high for hard metal cutting edges, as a result of which the cutting edges may crumble down. Using cutting members having hard metal cutting edges necessitates setting an as small as possible open cutting slit, particularly in order to achieve a flatness tolerance over larger lengths of the cutting members, which flatness tolerance is required for a cutting slit in a range from zero to the maximum allowable cutting slit.

The device according to the invention for that purpose on the one hand comprises a tensioning member for at least during cutting exerting a substantially constant transverse force. As a result the force the cutting edges exert on one another can be limited to the said constant transverse force that preferably can be set.

Furthermore the device according to the invention is provided with a stop member for bounding the movement of the guide rail, and therefore the second cutting edge, in the direction of the first cutting edge. In that way a clearance, that means a cutting slit in the range from zero to the maximum allowable cutting slit, of the first and second cutting edge can be set at least at the start of a cutting stroke.

Indeed the use of the tensioning member and the stop member provide a mechanism that keeps the transverse force under control and that makes the use of hard metal cutting edges possible for cutting cord-reinforced, unvulcanized rubber material.

In one embodiment the tensioning member comprises one or more pneumatic cylinders for providing the substantially constant transverse force, particularly during cutting. By setting a substantially constant pressure in the pneumatic cylinders a substantially constant transverse force is achieved, which may compensate a possible unevenness in the cutting edges.

In one embodiment the transverse force is in a range from 100 to 300 N, preferably in a range from 150 to 250 N. Such low transverse forces are impossible in the known devices. Due to the use of hard metal sharp cutting edges cord-reinforced, unvulcanized rubber material can be reliably cut with such low transverse forces.

In one embodiment the guide rail is hinged to the frame by means of a leaf spring. The leaf spring is active as rotation point and provides the freedom for the second cutting edge to move reciprocally in the direction of the first cutting edge, particularly for compensating unevenness in the first and/or second cutting edge. For compensating said unevenness a very small displacement or rotation is required that can be advantageously obtained with a leaf spring; in connection with the extremely small rotation bearings are not easy to use, particularly because of lubrication of such bearings when carrying out a rotation.

The leaf spring furthermore prevents a sideward movement of the guide rail, and therefore of the second cutting edge.

In one embodiment the first cutting member is a lower blade and the second cutting member is an upper blade.

In one embodiment the first and/or second cutting member comprises a long and, at least in longitudinal direction, straight and rigid blade that is provided with a cutting edge of hard metal. In one embodiment at the location of the cutting edge a hard metal cutting edge is soldered on a blade ledge.

In one embodiment the hard metal comprises tungsten carbide.

In one embodiment the first cutting member and the second cutting member together form a guillotine or a pair of scissors. In one embodiment the first and second cutting edge include an acute angle, particularly an angle larger than 0 degrees.

In one embodiment the second cutting member has a first and second outer end, and the tensioning member comprises at least two pneumatic cylinders, with a first pneumatic cylinder near a first outer end of the second cutting member and a second pneumatic cylinder near the other outer end.

In one embodiment the stop member is adapted for setting a cutting slit that is larger than or equal to zero. Also because of this a relatively small cutting force will suffice, and damage to the hard metal cutting edges can be substantially prevented.

In one embodiment the drive is adapted for, when operational, exerting a cutting force of less than 500 N, preferably less than 400 N. Such forces turn out to suffice for cutting steel cord of cord-reinforced, unvulcanized rubber material for manufacturing car tyres.

In one embodiment the drive comprises an eccentric drive. In one embodiment the eccentric drive carries substantially the entire weight of the second cutting member.

In one embodiment of the cutting device according to the invention it is adapted for cutting breaker plies for vehicle tyres.

In one embodiment of the cutting device according to the invention it is adapted for cutting other components for building vehicle tyres.

According to a second aspect the invention provides a method for cutting strips from a band of cord-reinforced unvulcanized rubber, by means of a cutting device as described above, wherein prior to and after cutting a strip from the band of cord-reinforced unvulcanized rubber, the position of the second cutting edge with respect to the first cutting edge is substantially defined by the stop member, and wherein during cutting the strip the position of the second cutting edge with respect to the first cutting edge is at least also defined by the substantially constant transverse force of the tensioning member. Prior to and after cutting a cutting slit can thus be set that is larger than or equal to zero. During cutting material, the material is between the cutting edges and the set cutting slit is irrelevant. During cutting the size of the cutting slit is at least also defined by the tensioning member at a substantially constant force pushing the second cutting edge to the first cutting edge.

In one embodiment, during cutting the strip the position of the second cutting edge with respect to the first cutting edge is substantially defined by the substantially constant transverse force of the tensioning member.

The embodiments described above can be combined.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### SHORT DESCRIPTION OF THE DRAWINGS

The invention will be elucidated on the basis of a number of exemplary embodiments shown in the attached drawings, in which:

FIG. 1 shows a schematic front view in cross-section of a cutting device according to the invention; and

FIG. 2 shows a schematic side view in cross-section of the cutting device of FIG. 1.

### DETAILED DESCRIPTION OF THE DRAWINGS

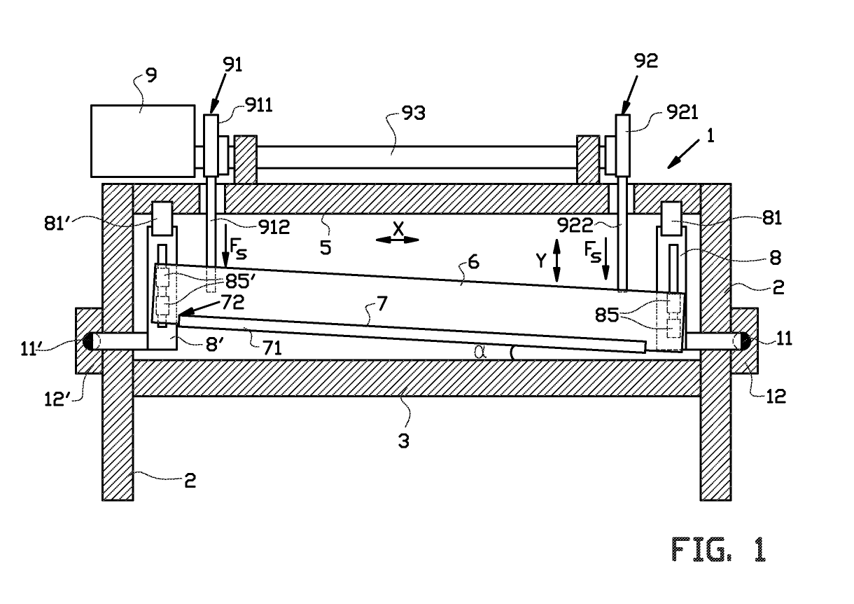

FIG. 1 shows a front view in cross-section of a cutting device 1 according to the invention. Said cutting device 1 has a frame 2, 3, 5, on which a lower blade beam 3 is mounted. In the lower blade beam 3 a lower blade 4 of hard metal is held. The cutting device 1 is furthermore provided with an upper frame 5 having an upper blade beam 6 that is provided with an upper blade 7 of hard metal. The lower blade 4 and/or the upper blade 7 are formed like a long and, at least in longitudinal direction, straight and rigid blade of hard metal, preferably of tungsten carbide.

Via guide blocks 85, the upper blade beam 6 is attached with a guide rail 8, as a result of which the upper blade beam 6 with the upper blade 7 is substantially rectilinearly Y movable in a substantially vertical direction. As a result the cutting edge 71 of the upper blade 7 is movable along the cutting edge 41 of the lower blade 4 for in cooperation with the cutting edge 41 of the lower blade 4 cutting the strips.

The upper blade 7 has a first 72 and second 73 outer end. For a proper guidance the upper blade beam 6 is placed on a guide rail 8, 8′ near each outer end 72, 73. Each of the said guide rails 8, 8′ is provided with a pneumatic cylinder 10.

As schematically shown in FIG. 1 the first cutting edge 41 and second cutting edge 71 include an acute angle α, particularly an angle larger than 0 degrees. When cutting the blades 4, 7 therefore are in fact making a scissoring motion.

At or near their upper outer end the guide rails 8, 8′ are hinged to the upper frame 5, with a hinge axis 82 that is substantially parallel to the first cutting edge 41. In the embodiment as shown in the figures, each guide rail 8, 8′ is one the one hand hinged to the upper frame 5 by means of a leaf spring 81, 81′. The leaf springs 81, 81′, as shown in FIG. 1, prevent sideward movement in X-direction of the guide rail 8, 8′ and provide a substantially stable position in X-direction of the upper blade 7. On the other hand the leaf springs 81, 81′ provide the freedom to swing forward and rearward about a hinge axis 82. The degree of forward and rearward movement at the level of the lower blade 4 is small, in the order of some tenths of millimetres or smaller. Also as a result of this, using bearings instead of leaf springs 81, 81′, has a drawback that the bearings are hard to lubricate, show wear and as a result introduce unwanted vibrations in the cutting motion.

A further advantage of leaf springs 81, 81′ for hinging the guide rails 8, 8′ to the frame 5 is that such a suspension substantially has no play, as a result of which the guide rail 8, 8′ is able to assume a properly defined position with respect to the frame; or in other words as a result of which the second cutting edge 71 is able to assume a properly defined position with respect to the first cutting edge 41.

At or near their lower outer end the guide rails 8, 9′ are attached to the frame 2 by means of a tensioning member 10. The tensioning member 10 comprises two pneumatic cylinders 101, one for each guide rail 8, 8′, for providing the substantially constant transverse force Fd, with which the guide rail 8, 8′ is pushed to the first cutting edge 41. In order to substantially prevent excessive wear of and/or damage to the hard metal blades 4, 7 the transverse force Fd is in a range from 100 to 300 N, preferably in a range from 150 to 250 N.

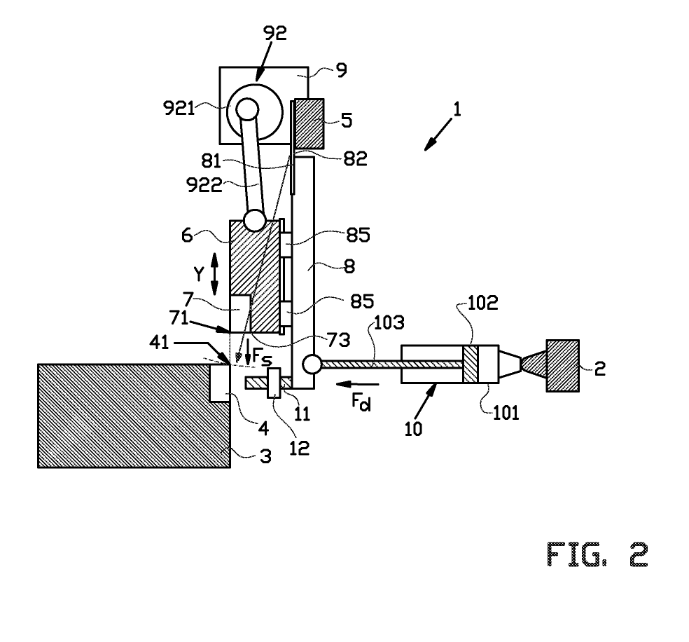

Each pneumatic cylinder 101 comprises a piston 102 which by means of a piston rod 103 is connected to the guide rail 8, as shown in FIG. 2. The cylinder 101 exerts a substantially constant force Fd on the guide rail 8 and therefore on the upper blade 7 in lateral direction for in that way, during carrying out the cutting motion, the downward cutting stroke, urging the upper blade 7 with its cutting edge 71 against the cutting edge 41 of the lower blade 4. In that way deviations of the hard metal blades 4, 7 particularly relating to the straightness of the cutting edges 41, 71, and/or deflections of the hard metal blades 4, 7, in case of reduced rigidity thereof, can be compensated by swinging the upper blade 7 forward and/or rearward in lateral direction about the hinge axis 82. Also due to this construction an exactly straight rotation line will not be required, but only two points of rotation, formed by the two leaf springs 81, 81′ are required.

The frame 2 comprises two stop members 11, 11′ for bounding the movement of the guide rail 8, 8′ in the direction of the first cutting edge 41. The stop members 11, 11′ are adapted for setting the cutting slit, particularly prior to and after cutting material, so that it is larger than or equal to zero, in order to substantially prevent excessive wear of and/or damage to the hard metal blades 4, 7. Each stop member 11, 11′ is placed in a holder 12, 12′ so as to be set, which holder is fixedly attached to, or is a part of the frame 2. In a simple embodiment the stop member 11, 11′ is at least partially provided with an external thread and the holder 12, 12′ is provided with a hole with complementary internal thread. By rotating the stop member 11, 11′ the stop position can be set.

The device furthermore comprises a drive 9 for driving the substantially rectilinear movement Y of the upper blade 7. The drive 9 comprises two eccentric drives 91, 92 which by means of an axis 93 are rotation-fixedly coupled.

Each of the eccentric drives 91, 92 comprises a disc 911, 921 having a connecting rod 912, 922 which is eccentrically and rotatably coupled thereto, and which at a side facing away from the disc 911, 921 is rotatably coupled to the upper blade beam 6. The connecting rods 912, 922 on the one hand ensure the drive of the movement of the upper blade beam 6 along the guide rail 8, and on the other hand carrying substantially the entire weight of the upper blade beam 6 with the upper blade 7. In this embodiment the two guide rails 8 therefore need not carry weight and they only serve for stable vertical guidance of the upper blade beam 6, for carrying out the substantially vertical guillotine motion of the upper blade 7. Moreover the leaf springs (81) and the hinge point (82) situated therein are not directly loaded by the cutting force Fs, as a result of which the construction of the cutting device according to the invention can be designed much more lightweight than the known cutting devices.

For cutting strips from a band of cord-reinforced unvulcanized rubber, particularly reinforced with steel cords, the drive is adapted for, when operational, exerting a cutting force Fs of less than 500 N, preferably less than 400 N. Also due to the use of hard metal blades 4, 7 that remain sharp much longer in comparison with tool steel blades, such low cutting forces suffice to cut the steel cords, particularly in a scissoring motion.

It will be clear that the above description is included to illustrate the operation of preferred embodiments of the invention and not to limit the scope of the invention. Starting from the above explanation many variations that fall within the spirit and scope of the present invention will be evident to an expert.

Summarising the invention relates to a cutting device for cutting strips from a band of cord-reinforced unvulcanized rubber. The device comprises a frame, a first and a second cutting member having a substantially straight first and second cutting edge, respectively, of a hard metal, wherein the first cutting member is fixedly attached to the frame, and the second cutting member is substantially rectilinearly movable by means of a guide rail that is attached to the frame. The second cutting edge is movable along the first cutting edge for cutting the strips. The guide rail on the one hand is hinged to the frame parallel to the first cutting edge, and on the other hand is attached to the frame by means of a tensioning member. The tensioning member is adapted for providing a constant transverse force with which the guide rail is pushed to the first cutting edge. The frame further comprises a stop member for bounding the movement of the guide rail to the first cutting edge.

1. Cutting device (1) for cutting strips from a band of cord-reinforced unvulcanized rubber, comprising
a frame (2, 3, 5),
a first cutting member (4) having a substantially straight first cutting edge (41), wherein the first cutting member (4) is fixedly attached to the frame (3),
a second cutting member (7) having a substantially straight second cutting edge (71), wherein the second cutting member is substantially rectilinearly (Y) movable by means of a guide rail (8) that is attached to the frame (5), wherein the second cutting edge (71) is movable along the first cutting edge (41) for in cooperation with the first cutting edge cutting the strips, and
a drive (9) for driving the substantially rectilinear movement (Y) of the second cutting member (7), and for carrying the second cutting member (7),
wherein the guide rail (8) on the one hand is hinged (81) to the frame (5), with a hinge axis (82) that is substantially parallel to the first cutting edge (41), and that the guide rail (8) on the other hand is attached to the frame (2) by means of a tensioning member (10), wherein the tensioning member (10) is adapted for, when operational, providing a substantially constant transverse force (Fd) with which the guide rail (8) is pushed to the first cutting edge (41),
wherein the first (41) and/or second (71) cutting edge is made of hard metal, and
wherein the frame (2) comprises a stop member (11) for bounding the movement of the guide rail (8) in the direction of the first cutting edge (41).

2. Cutting device according to claim 1, wherein the tensioning member (10) comprises one or more pneumatic cylinders for providing the substantially constant transverse force (Fd), particularly during cutting.

3. Cutting device according to claim 1, wherein the transverse force (Fd) is in a range from 100 to 300 N, preferably in a range from 150 to 250 N.

4. Cutting device according to claim 1, wherein the guide rail (8) on the one hand is hinged to the frame (5) by means of a leaf spring (81).

5. Cutting device according to claim 1, wherein the first cutting member is a lower blade (4) and the second cutting member is an upper blade (7).

6. Cutting device according to claim 1, preceding claims, wherein the first and/or second cutting member (4,7) is a long and, at least in longitudinal direction, straight and rigid blade that is provided with a cutting edge of hard metal.

7. Cutting device according to claim 6, wherein the hard metal comprises tungsten carbide.

8. Cutting device according to claim 1, wherein the first cutting member (4) and the second cutting member (7) together form a guillotine.

9. Cutting device according to claim 1, wherein the first and second cutting member (4, 7) together form a pair of scissors.

10. Cutting device according to claim 1, wherein the first and second cutting edge (41, 71) include an acute angle (α), particularly an angle larger than 0 degrees.

11. Cutting device according to claim 1, wherein the second cutting member (7) has a first (72) and second (73) outer end, and the tensioning member (10) comprises at least two pneumatic cylinders, with a first pneumatic cylinder near a first outer end (72) of the second cutting member and a second pneumatic cylinder near the second outer end (73).

12. Cutting device according to claim 1, wherein the stop member (11) is adapted for setting a cutting slit that is larger than or equal to zero.

13. Cutting device according to claim 1, wherein the drive comprises an eccentric drive (91, 92).

14. Cutting device according to claim 13, wherein the eccentric drive (91, 92) carries substantially the entire weight of the second cutting member (7).

15. Cutting device according to claim 1, wherein the drive is adapted for, when operational, exerting a cutting force (Fs) of less than 500 N, preferably less than 400 N.

16. Method for cutting strips from a band of cord-reinforced unvulcanized rubber, by means of a cutting device according to any one of the preceding claims,
wherein prior to and after cutting a strip from the band of cord-reinforced unvulcanized rubber, the position of the second cutting edge (71) with respect to the first cutting edge (41) is substantially defined by the stop member (11), and
wherein during cutting the strip the position of the second cutting edge (71) with respect to the first cutting edge (41) is at least also defined by the substantially constant transverse force (Fd) of the tensioning member (10).

17. Method according to claim 16, wherein during cutting the strip the position of the second cutting edge (71) with respect to the first cutting edge (41) is substantially defined by the substantially constant transverse force (Fd) of the tensioning member (10).
